(19) United States
(12) Patent Application Publication
(10) Pub. No.: US 2014/0333751 A1
(43) Pub. Date: Nov. 13, 2014

(54) IMAGE PROCESSING APPARATUS AND SYSTEM, METHOD FOR PROCESSING IMAGE, AND PROGRAM

(71) Applicant: CANON KABUSHIKI KAISHA, Tokyo (JP)

(72) Inventors: Tomohiko Takayama, Tokyo (JP); Toru Sasaki, Yokohama-shi (JP)

(21) Appl. No.: 14/369,092

(22) PCT Filed: Dec. 14, 2012
(86) PCT No.: PCT/JP2012/008024

§ 371 Date: Jun. 26, 2014

(30) Foreign Application Priority Data
Dec. 27, 2011 (JP) 2011-286779
Oct. 12, 2012 (JP) 2012-226899

(51) Int. Cl. G02B 21/36; G09G 5/14; G06T 1/00

(52) U.S. Cl. CPC G02B 21/367; G06T 1/0007; G09G 5/14
USPC 348/79

(57) ABSTRACT

An image processing apparatus includes an image data acquisition unit, a display control unit, an area-information acquisition unit, and a detection unit. The image data acquisition unit acquires Z-stack image data including multiple layer images obtained by using a microscope apparatus. The display control unit displays at least one of the layer images on a display apparatus as an observation image. The area-information acquisition unit acquires information about a target area in the observation image specified by a user. The detection unit detects in-focus information for a corresponding area for the target area in each of the layer images. The display control unit displays an image indicating a positional relationship between the target area and the corresponding area which is closer to an in-focus state than the target area, along with the target area on the display apparatus, based on the result from the detection unit.

### TECHNICAL FIELD

The present invention relates to an image processing apparatus, an image processing system, a method for processing an image, and a program which process virtual slide images.

### BACKGROUND ART

Attention is being given to virtual slide systems in which virtual slide images can be obtained by capturing images of the specimen on a preparation by using a digital microscope, and in which these virtual slide images can be displayed on a monitor so as to be observed (see PTL 1).

In addition, it is known that Z-stack image data (depth images) including multiple layer images is used as virtual slide images (see PTL 2).

When a structure in an observation image displayed on a monitor is not in focus, a user can focus the structure by changing the Z position (depth) for virtual slide images.

However, there is a problem in that a user cannot intuitively find in which direction the depth for the virtual slide images is to be changed.

### CITATION LIST

### Patent Literature

PTL 1: Japanese Patent Laid-Open No. 2011-118107

PTL 2: Japanese Patent Laid-Open No. 2011-204243

### SUMMARY OF INVENTION

The present invention provides an image processing apparatus which processes virtual slide images in such a manner that a user can intuitively and easily find in which direction the depth for the virtual slide images is to be changed.

An image processing apparatus according to an aspect of the present invention includes an image data acquisition unit, a display control unit, an area-information acquisition unit, and a detection unit. The image data acquisition unit acquires Z-stack image data including multiple layer images obtained by using a microscope apparatus. The display control unit displays at least one of the multiple layer images on a display apparatus as an observation image. The area-information acquisition unit acquires information about a target area in the observation image specified by a user. The detection unit detects in-focus information for a corresponding area in each of the multiple layer images, and the corresponding area corresponds to the target area. The display control unit displays an image indicating a positional relationship between the target area and the corresponding area which is closer to an in-focus state than the target area, along with the target area on the display apparatus on the basis of the detection result from the detection unit.

The image processing apparatus according to the aspect of the present invention can process virtual slide images in such a manner that a user can intuitively and easily find in which direction the depth for the virtual slide images is to be changed.

Further features of the present invention will become apparent from the following description of exemplary embodiments with reference to the attached drawings.

### BRIEF DESCRIPTION OF DRAWINGS

FIG. 1 is an overall view of the apparatus configuration of an image pickup system.

FIG. 2 is a block diagram illustrating the functional configuration of an image pickup apparatus.

FIG. 3 is a schematic diagram describing multiple images obtained at different focal positions.

FIG. 4 is a flowchart of image presentation.

FIG. 5 is a flowchart of detection of in-focus information.

FIG. 6A is a schematic diagram describing multiple target areas.

FIG. 6B is a table describing in-focus information for multiple target areas.

FIG. 7A is a schematic diagram illustrating a target-area specification screen.

FIG. 7B is a schematic diagram illustrating an auxiliary-area presentation screen.

FIG. 8 is a schematic diagram illustrating a target-area specification screen and an auxiliary-area presentation screen.

FIG. 9 is a flowchart of detection of in-focus information for an inferred structure.

FIG. 10A is a schematic diagram illustrating a target-area specification screen.

FIG. 10B is a schematic diagram illustrating an auxiliary-area presentation screen.

FIG. 11A is a diagram illustrating in-focus information corresponding to multiple target areas obtained at different focal positions.

FIG. 11B is a table showing the relationship among a position in the depth direction, in-focus information, and a priority.

FIG. 11C is a table showing the relationship among a memory storage number, a priority, and the depth position of a target area to be stored.

FIG. 12 is a flowchart describing priorities assigned to target areas.

FIG. 13A is a schematic diagram describing a cell clump.

FIG. 13B is a schematic diagram describing in-focus information for a cell clump.

FIG. 14 is a schematic diagram illustrating an auxiliary-area presentation screen.

FIG. 15A is a schematic diagram describing switching of a target area (observation area) in an auxiliary-area presentation screen (before the switching).

FIG. 15B is a schematic diagram describing switching of a target area (observation area) in an auxiliary-area presentation screen (after the switching).

FIG. 16 is a schematic diagram describing the relationship between the number of Z stacks in a structure and the number of Z stacks to be displayed.

FIG. 17 is a diagram illustrating the hardware configuration of an image processing apparatus.

FIG. 18 is a functional block diagram of the controller of an image processing apparatus.

FIG. 19 is a functional block diagram of the display-candidate-image generation unit of the controller of an image processing apparatus.

FIG. 20 is a functional block diagram of the display-candidate-image generation unit of the controller of an image processing apparatus according to a second embodiment.

### DESCRIPTION OF EMBODIMENTS

Embodiments of the present invention will be described below with reference to the drawings.

### First Embodiment

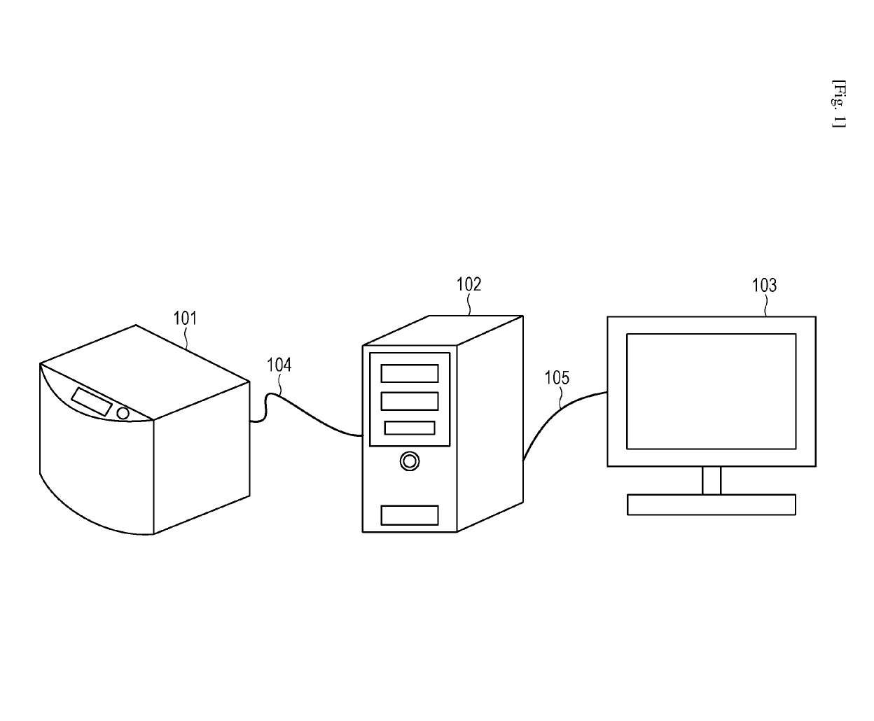

FIG. 1 is an overall view of the apparatus configuration of an image pickup system. The image pickup system according to a first embodiment includes an image pickup apparatus 101 and an image processing system having an image processing apparatus 102 and a display apparatus 103, and has a function of obtaining and displaying two-dimensional images of a subject (sample) which is a target. The image pickup apparatus 101 and the image processing apparatus 102 are connected to each other through a cable 104 which is a dedicated interface (I/F) or a general-purpose I/F, whereas the image processing apparatus 102 and the display apparatus 103 are connected to each other through a cable 105 which is a general-purpose I/F.

The image pickup apparatus 101 is a microscope apparatus (virtual slide apparatus) that has a function of capturing multiple two-dimensional images at different focal positions in the optical-axis direction and outputting digital images. A solid-state image sensing element, such as a charge-coupled device (CCD) or a complementary metal oxide semiconductor (CMOS), is used to obtain a two-dimensional image. Instead of a virtual slide apparatus, the image pickup apparatus 101 may include a digital microscope apparatus in which a digital camera is attached to an eyepiece portion of a typical optical microscope.

The image processing apparatus 102 generates multiple observation images, each of which has a desired focal position and a desired depth of field, from multiple layer images obtained from the image pickup apparatus 101, and displays them on the display apparatus 103 so as to aid in microscope observation performed by a user. The image processing apparatus 102 has, as main functions, an image data acquisition function of acquiring Z-stack image data, an image generation function of generating observation images from the Z-stack image data, and a display control function of displaying the observation images on the display apparatus 103. The image processing apparatus 102 according to the first embodiment also has an area-information acquisition function of acquiring information about target areas specified by a user, a detection function of detecting in-focus information for the target areas, a priority-assigning function of assigning priorities to image data, and a storage function of storing the image data in a storage device. The image processing apparatus 102 is constituted by a general-purpose computer or workstation which includes hardware resources, such as a central processing unit (CPU), a random-access memory (RAM), a storage device, an operation unit, and an I/F. The storage device is a mass information storage device such as a hard disk drive, and stores, for example, programs, data, and an operating system (OS) for achieving processes described below. The above-described functions are achieved with the CPU loading necessary programs and data from the storage device onto the RAM and executing the programs. The operation unit is constituted by, for example, a keyboard and a mouse, and is used by an operator to input various instructions. The display apparatus 103 is a monitor that displays the multiple two-dimensional images which are the results of computation performed by the image processing apparatus 102, and is constituted by, for example, a cathode-ray tube (CRT) or a liquid crystal display.

In the example in FIG. 1, an image pickup system (virtual slide system) is constituted by three apparatuses which are the image pickup apparatus 101, the image processing apparatus 102, and the display apparatus 103. However, the configuration of the present invention is not limited to this. For example, an image processing apparatus into which a display apparatus is integrated may be used, or the function of an image processing apparatus may be incorporated into an image pickup apparatus. Alternatively, the functions of an image pickup apparatus, an image processing apparatus, and a display apparatus may be achieved in a single apparatus. On the other hand, the function of, for example, an image processing apparatus may be divided into small functions which are performed in multiple apparatuses.

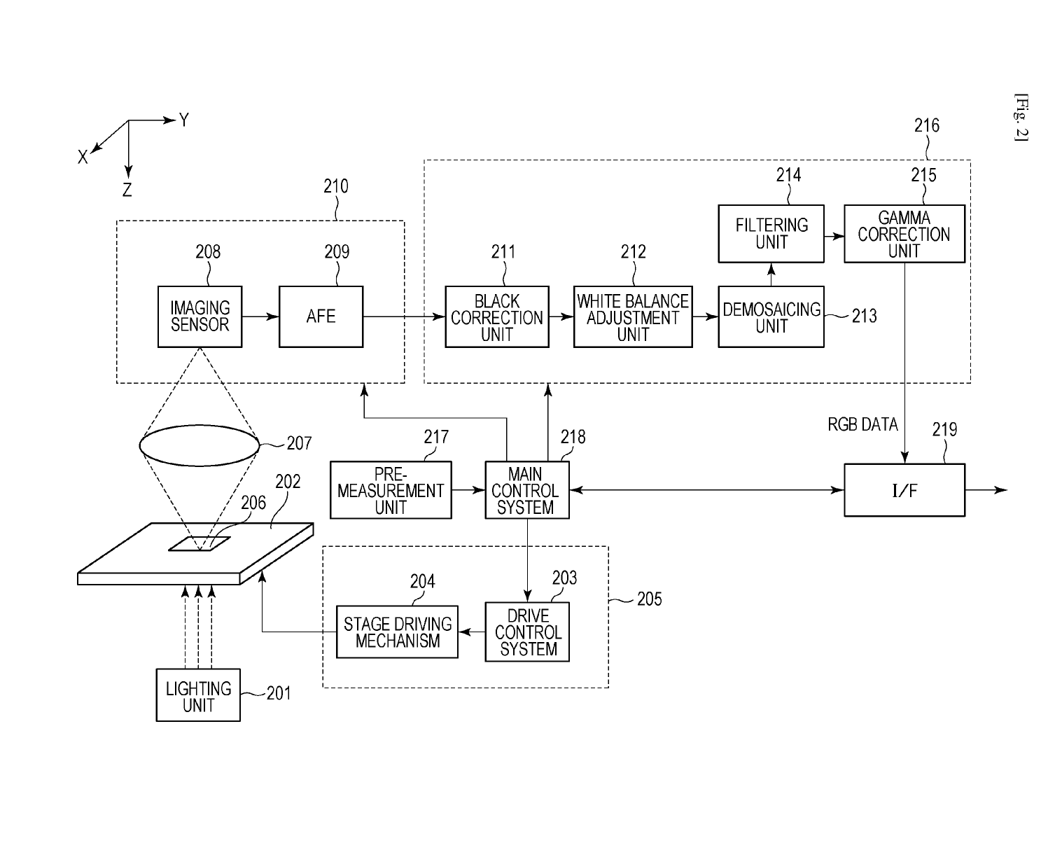

FIG. 2 is a block diagram illustrating the functional configuration of the image pickup apparatus 101. The image pickup apparatus 101 generally includes a lighting unit 201, a stage 202, a stage control unit 205, an imaging optical system 207, an image pickup unit 210, a development processing unit 216, a pre-measurement unit 217, a main control system 218, and an external interface 219.

The lighting unit 201 is a unit which uniformly irradiates a slide 206, which is located on the stage 202, with light, and includes a light source, an illumination optical system, and a control system for driving the light source. The stage 202 is driven and controlled by the stage control unit 205, and can be moved in the three XYZ axes. It is assumed that the optical-axis direction is the Z direction. The slide 206 is a member in which a slice of tissue or a smear cell which serves as an observation object is put onto the slide glass so as to be held together with a mounting agent under the cover glass.

The stage control unit 205 includes a drive control system 203 and a stage driving mechanism 204. The drive control system 203 receives an instruction from the main control system 218, and controls driving of the stage 202. The moving direction, the moving amount, and the like of the stage 202 are determined on the basis of the position information and the thickness information (distance information) of a specimen which are measured by the pre-measurement unit 217, and on the basis of an instruction from a user. The stage driving mechanism 204 drives the stage 202 in accordance with an instruction from the drive control system 203.

The imaging optical system 207 is a lens unit for forming an optical image of a specimen on the slide 206 onto an imaging sensor 208.

The image pickup unit 210 includes the imaging sensor 208 and an analog front end (AFE) 209. The imaging sensor 208 is a one-dimensional or two-dimensional image sensor which converts a two-dimensional optical image into an electrical physical quantity through photoelectric conversion, and, for example, a CCD or a CMOS is used. When a one-dimensional sensor is used, a two-dimensional image is obtained by performing scanning in a scanning direction. An electric signal having a voltage value according to light intensity is output from the imaging sensor 208. In the case where a color image is desired as a captured image, for example, a single-chip image sensor to which a color filter using a Bayer array is attached may be used.

The AFE 209 is a circuit that converts an analog signal which is output from the imaging sensor 208 into a digital signal. The AFE 209 includes a horizontal/vertical (H/V) driver, a correlated double sampling circuit (CDS), an amplifier, an analog-to-digital (AD) converter, and a timing generator, which are described below. The H/V driver converts a vertical synchronizing signal and a horizontal synchronizing signal for driving the imaging sensor 208 into a potential which is necessary to drive the sensor. The CDS is a correlated double sampling circuit which removes fixed-pattern noise. The amplifier is an analog amplifier which adjusts a gain of an analog signal which has been subjected to noise reduction in the CDS. The AD converter converts an analog signal into a digital signal. In the case where an output from the final stage of the system is 8-bit, the AD converter converts an analog signal into digital data obtained through approximately 10-bit to 16-bit quantization, with consideration of downstream processes, and outputs the digital data. The converted sensor output data is called RAW data. The RAW data is subjected to a development process in the development processing unit 216 which is located downstream. The timing generator generates a signal for adjusting timing for the imaging sensor 208 and timing for the development processing unit 216 which is located downstream.

In the case where a CCD is used as the imaging sensor 208, the above-described AFE 209 is necessary. In contrast, in the case where a CMOS image sensor which can output a digital output is used, the sensor includes the function of the above-described AFE 209. In addition, an image pickup controller (not illustrated) which controls the imaging sensor 208 is present, and controls not only the operations of the imaging sensor 208 but also operation timing, such as a shutter speed, a frame rate, and a region of interest (ROI).

The development processing unit 216 includes a black correction unit 211, a white balance adjustment unit 212, a demosaicing unit 213, a filtering unit 214, and a gamma correction unit 215. The black correction unit 211 subtracts data for black correction obtained with light being shielded, from each of the pixels of the RAW data. The white balance adjustment unit 212 adjusts a gain of each of the RGB colors in accordance with the color temperature of light from the lighting unit 201 so as to reproduce desired white. Specifically, data for white balance correction is added to the RAW data after the black correction. In the case where a monochrome image is handled, the white balance adjustment process is not necessary.

The demosaicing unit 213 generates image data for each of the RGB colors from the RAW data according to the Bayer array. The demosaicing unit 213 calculates RGB-color values of a target pixel through interpolation using values of the surrounding pixels (including pixels of the same color and pixels of other colors) in the RAW data. In addition, the demosaicing unit 213 performs a correction process (complement process) on a defective pixel. In the case where the imaging sensor 208 has no color filters and where a monochrome image is obtained, the demosaicing process is not necessary.

The filtering unit 214 is a digital filter which achieves suppression of high-frequency components included in an image, noise reduction, and emphasis of high resolution. The gamma correction unit 215 adds the inverse of gradation expression characteristics of a typical display device to an image, and performs gradation conversion in accordance with the visual property of a man through gradation compression in a high-luminance portion or dark processing. According to the first embodiment, to obtain an image for morphological observation, an image is subjected to gradation conversion which is adequate for a synthesizing process and a display process which are located downstream.

A typical development process includes color space conversion for converting a RGB signal into a luminance/chrominance signal, such as YCC, and compression of large-volume image data. According to the first embodiment, RGB data is directly used, and data compression is not performed.

A lens unit included in the imaging optical system 207 exerts an influence so as to reduce the light quantity in a surrounding portion in the image pickup area. To correct such reduction, the development processing unit 216 may include a function of correcting reduction in light in a surrounding portion. Similarly, the development processing unit 216 may include correction functions for various types of optical systems, such as distortion correction for correcting a position shift of the formed image, and lateral chromatic aberration correction for correcting the difference in the sizes of images for each color, among various aberrations which occur in the imaging optical system 207.

The pre-measurement unit 217 performs pre-measurement for calculating position information of the specimen on the slide 206, distance information to the desired focal position, and parameters for light-quantity adjustment caused by the thickness of the specimen. The pre-measurement unit 217 obtains information before the main measurement, enabling images to be efficiently captured. In addition, the start position, the end position, and intervals at which multiple images are captured are specified on the basis of information generated by the pre-measurement unit 217.

The main control system 218 controls various units described above. The functions of the main control system 218 and the development processing unit 216 are achieved by a control circuit having a CPU, a ROM, and a RAM. That is, the ROM stores programs and data, and the CPU uses the RAM as a work memory so as to execute the programs, achieving the functions of the main control system 218 and the development processing unit 216. A device, such as an electrically erasable programmable ROM (EEPROM) or a flash memory, is used as the ROM, and a dynamic random access memory (DRAM) device using, for example, double data rate 3 (DDR3) is used as the RAM.

The external interface 219 is an interface for transmitting a RGB color image generated by the development processing unit 216 to the image processing apparatus 102. The image pickup apparatus 101 and the image processing apparatus 102 are connected to each other through an optical communications cable. Alternatively, an interface, such as a Universal Serial Bus (USB) or a GigabitEthernet (registered trademark) is used.

The process flow for capturing an image in the main measurement will be briefly described. The stage control unit 205 determines a position at which an image is to be captured for the specimen on the stage 202 on the basis of the information obtained through the pre-measurement. Light emitted from the lighting unit 201 penetrates the specimen, and an image is formed through the imaging optical system 207 onto the image pickup surface of the imaging sensor 208. The AFE 209 converts the output signal from the imaging sensor 208 into a digital image (RAW data) which is converted into two-dimensional image of RGB by the development processing unit 216. The two-dimensional image thus obtained is transmitted to the image processing apparatus 102.

The above-described configuration and processes enable a two-dimensional image of a specimen to be captured at a certain focal position. While the stage control unit 205 shifts the focal position in the optical-axis direction (Z direction), the above-described image pickup process is repeated, whereby multiple two-dimensional images are captured at different focal positions. Herein, each of the two-dimensional images obtained through the image pickup process in the main measurement is called a layer image, and the multiple two-dimensional images (layer images) are collectively called Z-stack image data.

In the first embodiment, an example is described in which a color image is obtained using a single-chip image sensor. A three-chip method may be employed in which three image sensors corresponding to respective RGB colors are used to obtain a color image. Alternatively, a three-time image pickup method may be employed to capture a color image by using one image sensor and a three-color light source to capture an image three times while the color of the light source is switched from one to another.

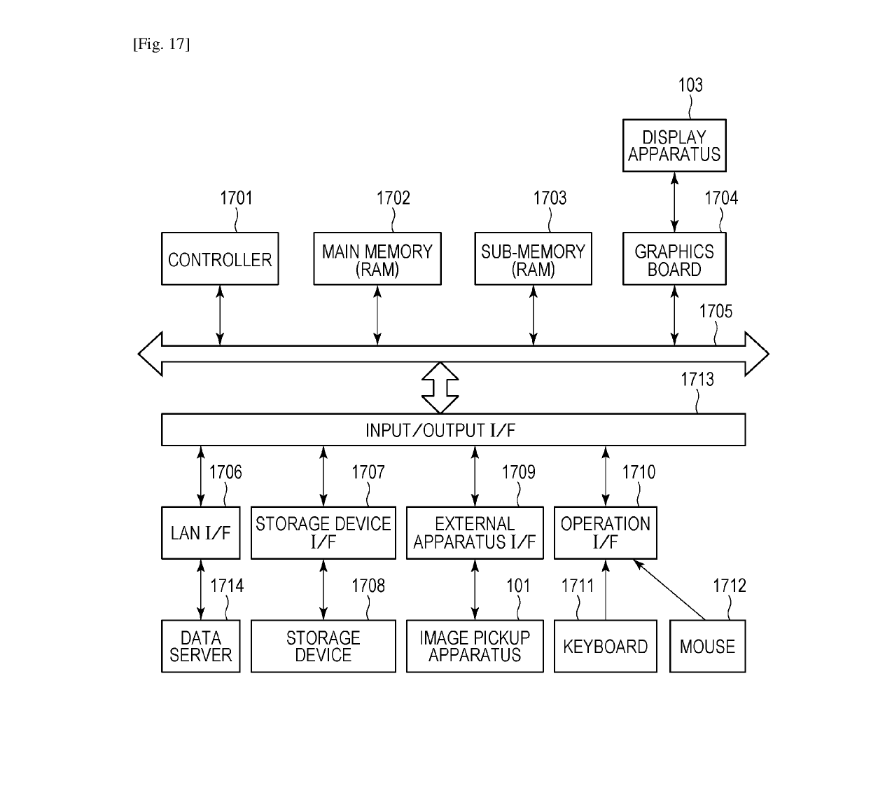

FIG. 17 is a block diagram illustrating the hardware configuration of the image processing apparatus 102. For example, a personal computer (PC) is used as an apparatus for performing information processing. The PC includes a controller 1701, a main memory 1702, a sub-memory 1703, a graphics board 1704, and an internal bus 1705 which connects these to one another. The PC further includes a LAN I/F 1706, a storage device I/F 1707, an external apparatus I/F 1709, an operation I/F 1710, and an input/output I/F 1713 which connects these to one another.

The controller 1701 accesses, for example, the main memory 1702 and the sub-memory 1703 when necessary, and has overall control of the entire blocks in the PC while performing various computation processes. The main memory 1702 and the sub-memory 1703 are constituted by RAMs. The main memory 1702 is used as, for example, a work area for the controller 1701, and temporarily stores the OS, various programs that are being executed, and various types of data to be processed for, for example, generation of display data. In addition, the main memory 1702 and the sub-memory 1703 are also used as a storage area for image data. The direct memory access (DMA) function of the controller 1701 achieves fast transfer of image data between the main memory 1702 and the sub-memory 1703, and between the sub-memory 1703 and the graphics board 1704. The graphics board 1704 outputs an image processing result to the display apparatus 103. The display apparatus 103 is a display device using, for example, liquid crystal or electro-luminescence (EL). In the configuration, it is assumed that the display apparatus 103 is connected as an external apparatus. Alternatively, it may be assumed that a display apparatus is incorporated in a PC. This configuration corresponds to, for example, a notebook PC.

To the input/output I/F 1713, a data server 1714 is connected via the LAN I/F 1706; a storage device 1708, via the storage device I/F 1707; the image pickup apparatus 101, via the external apparatus I/F 1709; and a keyboard 1711 and a mouse 1712, via the operation I/F 1710.

The storage device 1708 is an auxiliary storage device which records and reads out the OS executed by the controller 1701, and information permanently stored as firmware, such as programs and various parameters. The storage device 1708 is also used as a storage area for layer image data transmitted from the image pickup apparatus 101. A magnetic disk drive, such as a hard disk drive (HDD) or a solid state disk (SSD), or a semiconductor device using a flash memory is used as the storage device 1708.

It is assumed that a pointing device, such as the keyboard 1711 or the mouse 1712, is a device equipped with the operation I/F 1710. A configuration may be employed in which the screen of the display apparatus 103 serves as a direct input device, e.g., a touch panel. In this case, the touch panel may be integrated with the display apparatus 103.

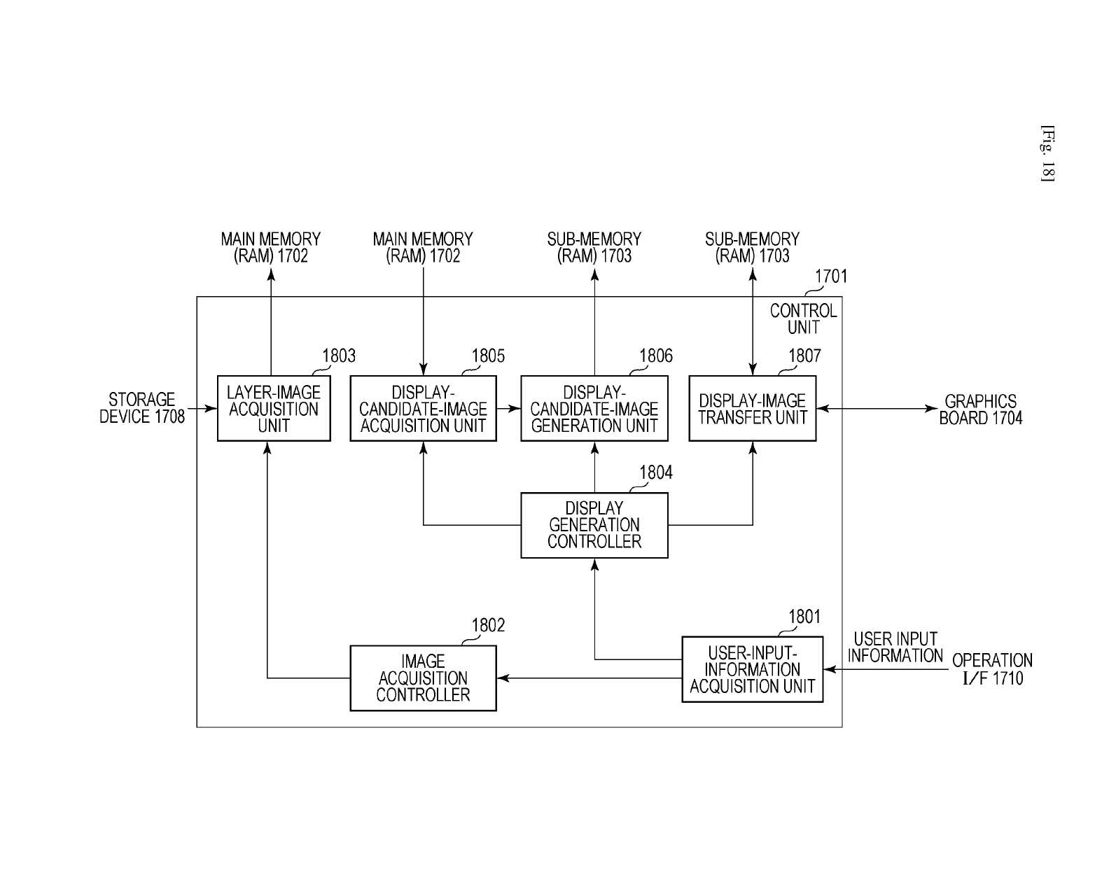

FIG. 18 is a block diagram illustrating the functional configuration of the controller 1701 of the image processing apparatus 102. The controller 1701 includes a user-input-information acquisition unit 1801, an image acquisition controller 1802, a layer-image acquisition unit 1803, a display generation controller 1804, a display-candidate-image acquisition unit 1805, a display-candidate-image generation unit 1806, and a display-image transfer unit 1807.

The user-input-information acquisition unit 1801 obtains, through the operation I/F 1710, instructions that are input by a user through the keyboard 1711 or the mouse 1712, such as a start and an end of image display, and scrolling, zooming-in, and zooming-out of a displayed image.

The image acquisition controller 1802 controls an image data area that is read out from the storage device 1708 and that is developed onto the main memory 1702 on the basis of the user input information. The image acquisition controller 1802 determines an image area which is expected to be required as a display image, with respect to the various types of user input information, such as a start and an end of image display, and scrolling, zooming-in, and zooming-out of a displayed image. When the main memory 1702 does not store the image area, the image acquisition controller 1802 instructs the layer-image acquisition unit 1803 to read out layer images in the image area from the storage device 1708 and to develop it onto the main memory 1702. Since readout from the storage device 1708 takes time, it is desirable to make the image area to be read out, as broad as possible so as to reduce overhead for the readout process.

The layer-image acquisition unit 1803 reads out the layer images in the image area from the storage device 1708 and stores them in the main memory 1702 in accordance with the control from the image acquisition controller 1802.

The display generation controller 1804 controls an image area to be read out from the main memory 1702 on the basis of the user input information, a method for processing the image area, and a display-image area to be transferred to the graphics board 1704. The display generation controller 1804 detects a display candidate image area that is expected to be required as a display image, and a display-image area and a target area that are actually displayed on the display apparatus 103, on the basis of the various types of user input information, such as a start and an end of image display, and scrolling, zooming-in, and zooming-out of a displayed image. When the sub-memory 1703 does not store the candidate image area, the display generation controller 1804 instructs the display-candidate-image acquisition unit 1805 to read out the display candidate image area from the main memory 1702. At the same time, the display generation controller 1804 transmits an instruction about how to process a scroll request, to the display-candidate-image generation unit 1806. In addition, the display generation controller 1804 instructs the display-image transfer unit 1807 to read out the display-image area from the sub-memory 1703. The readout of image data from the main memory 1702 is performed faster than the readout from the storage device 1708. Accordingly, the above-described display candidate image area is narrower than the broad image area obtained by the image acquisition controller 1802.

The display-candidate-image acquisition unit 1805 reads out the image areas of the layer images, which are display candidates, from the main memory 1702, and transfers them to the display-candidate-image generation unit 1806, in accordance with the control instruction from the display generation controller 1804.

The display-candidate-image generation unit 1806 expands the display candidate image data (layer image data) which is compressed image data, detects pieces of in-focus information for the target areas to be displayed on the display apparatus 103, assigns priorities to them, and develops the obtained information onto the sub-memory 1703.

The display-image transfer unit 1807 reads out the display images from the sub-memory 1703, and transfers them to the graphics board 1704, in accordance with the control instruction from the display generation controller 1804. The display-image transfer unit 1807 performs fast image data transfer between the sub-memory 1703 and the graphics board 1704 by using the DMA function.

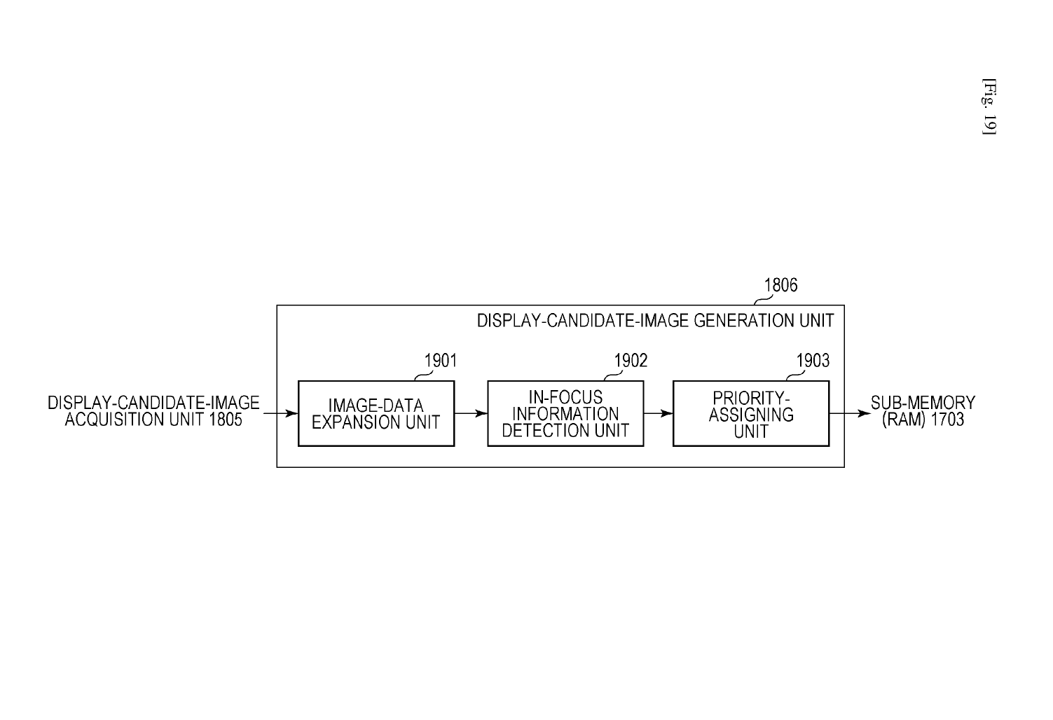

FIG. 19 is a block diagram illustrating the functional configuration of the display-candidate-image generation unit 1806 of the controller 1701 of the image processing apparatus 102. An image-data expansion unit 1901 expands the display candidate image data (layer image data) which is compressed image data.

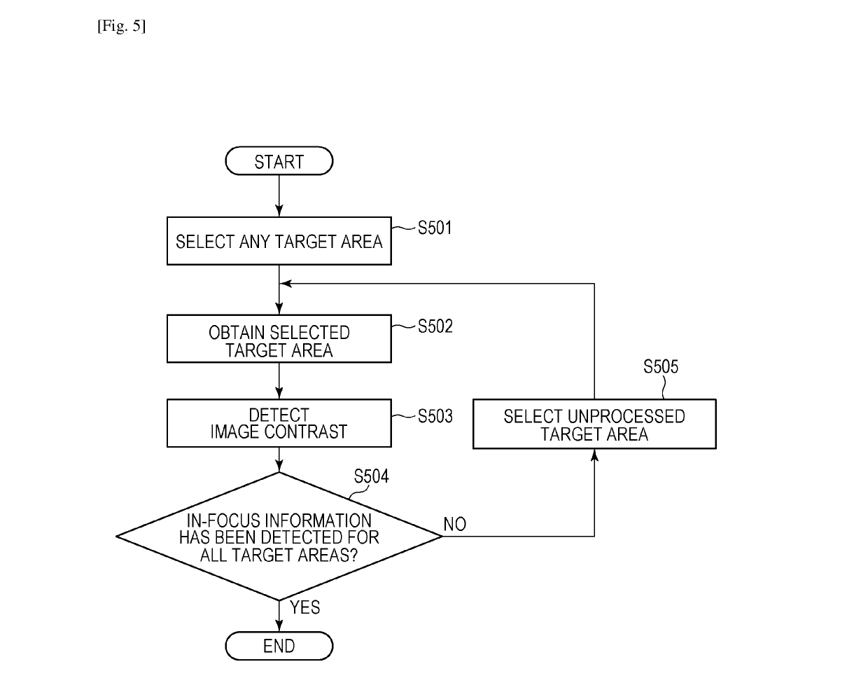

An in-focus information detection unit 1902 detects an image contrast, which is the in-focus information, for each of the target areas in the layer images to be displayed on the display apparatus 103. The process flow of detection of the in-focus information, and the in-focus information will be described with reference to FIG. 5.

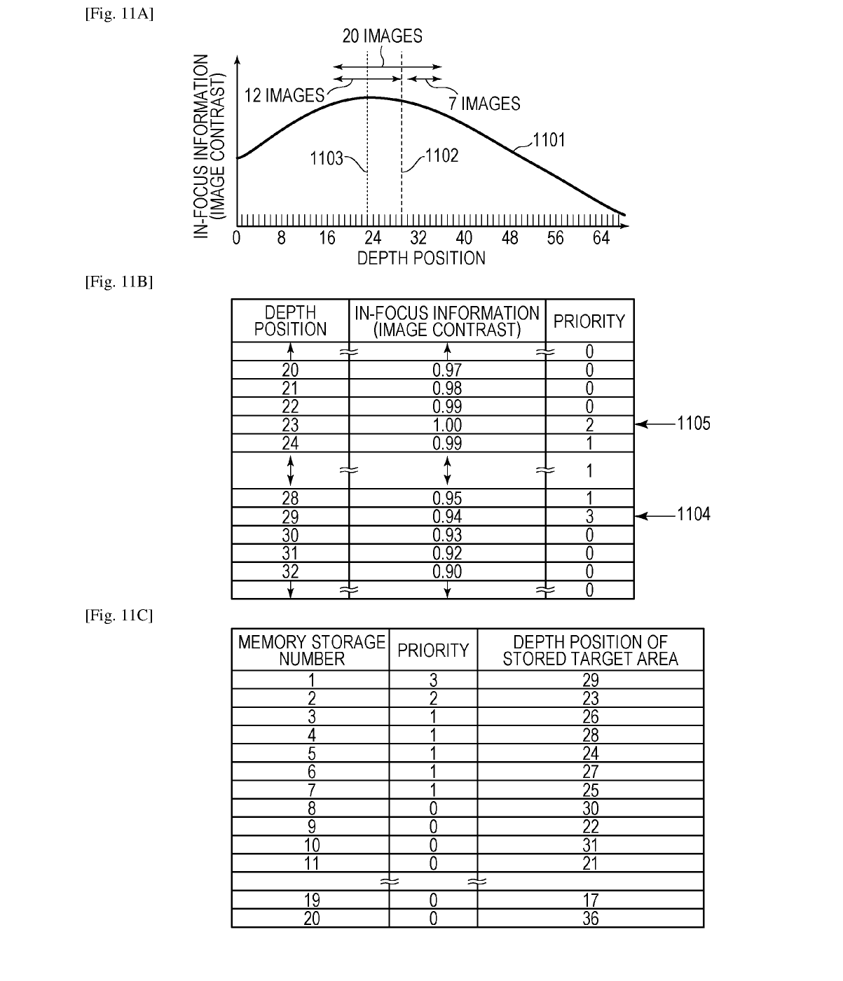

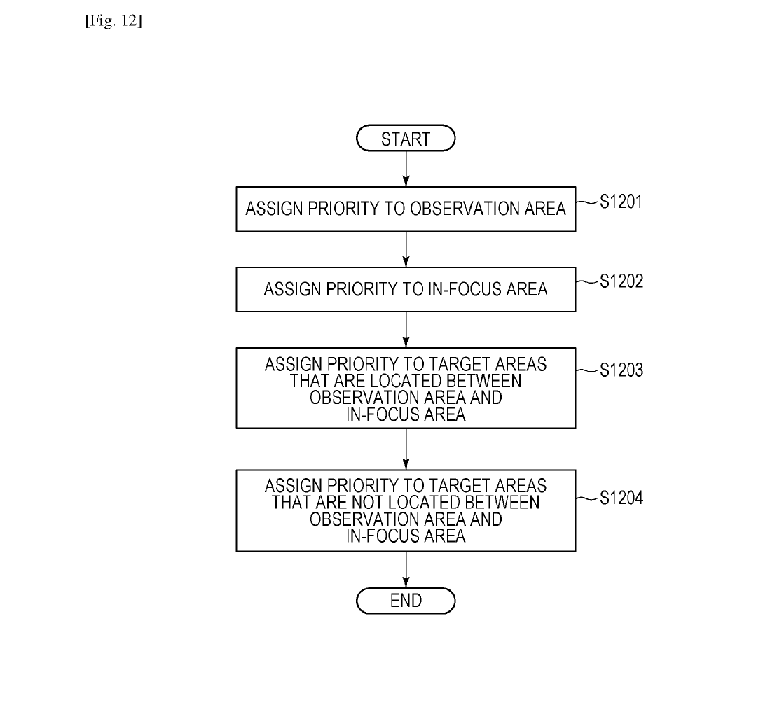

A priority-assigning unit 1903 assigns priorities to the target areas on the basis of the in-focus information detected by the in-focus information detection unit 1902, and stores the in-focus information, the priority information, and the layer images onto the main memory 1702. The priority to the target areas and the process flow of assigning priorities will be described with reference to FIGS. 11A to 12.

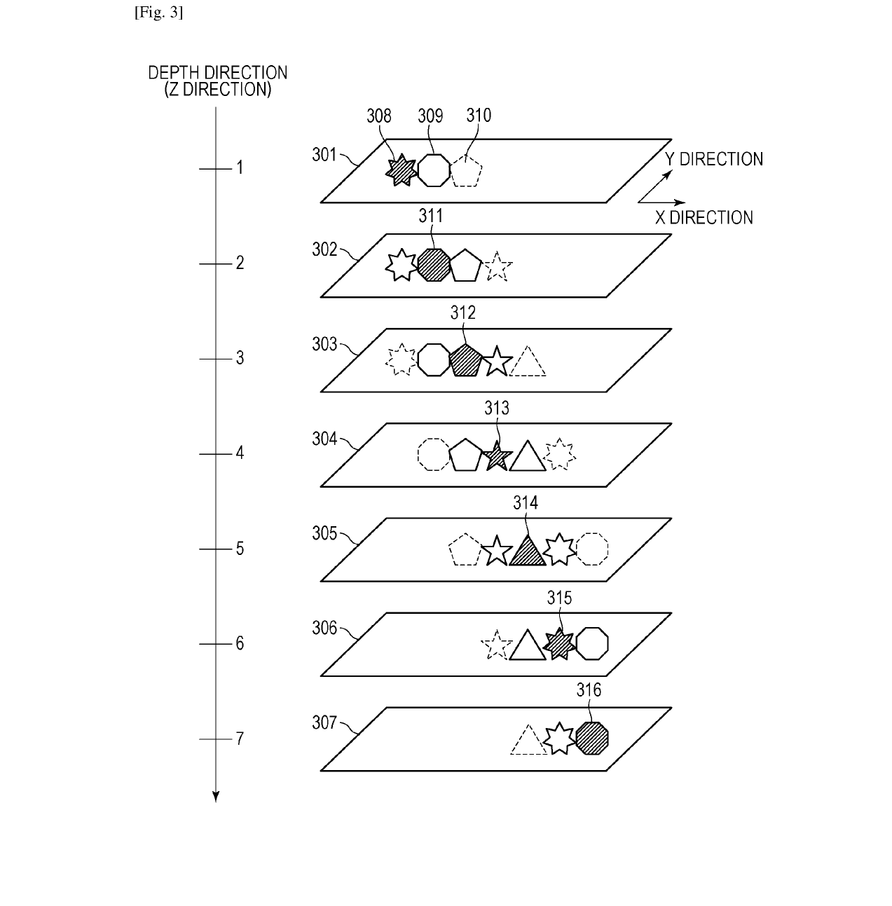

FIG. 3 is a schematic diagram describing multiple images obtained at different focal positions. Seven layer images 301 to 307 are obtained by capturing an image of a subject (sample), in which multiple observation objects are included at different three-dimensional space positions, seven times while the focal position is sequentially changed in the optical-axis direction (Z direction). The obtained layer image 301 includes observation objects 308 to 310. The observation object 308 is in focus at the focal position of the layer image 301, but is out of focus at the focal position of the layer image 303. Therefore, it is difficult to grasp the structure of the observation object 308 in the layer image 303. The observation object 309 is in focus at the focal position of layer image 302, but is slightly out of focus at the focal position of the layer image 301. The structure of the observation object 309 is possibly, but not sufficiently, grasped in the layer image 301. The observation object 310 is in focus at the focal position of the layer image 303. Accordingly, it is possible to sufficiently grasp the structure of the observation object 310 by using the layer image 303.

In FIG. 3, a black observation object represents an in-focus object; a white observation object, a slightly blurred object; and an observation object drawn with a dashed line, a blurred object. That is, the observation object 308 is in focus in the layer image 301; and observation objects 311 to 316 are in focus in the layer images 302 to 307, respectively. In the example illustrated in FIG. 3, description will be made under the assumption that the observation objects 308 and 311 to 316 are located at different positions in a plane perpendicular to the optical-axis direction (Z direction).

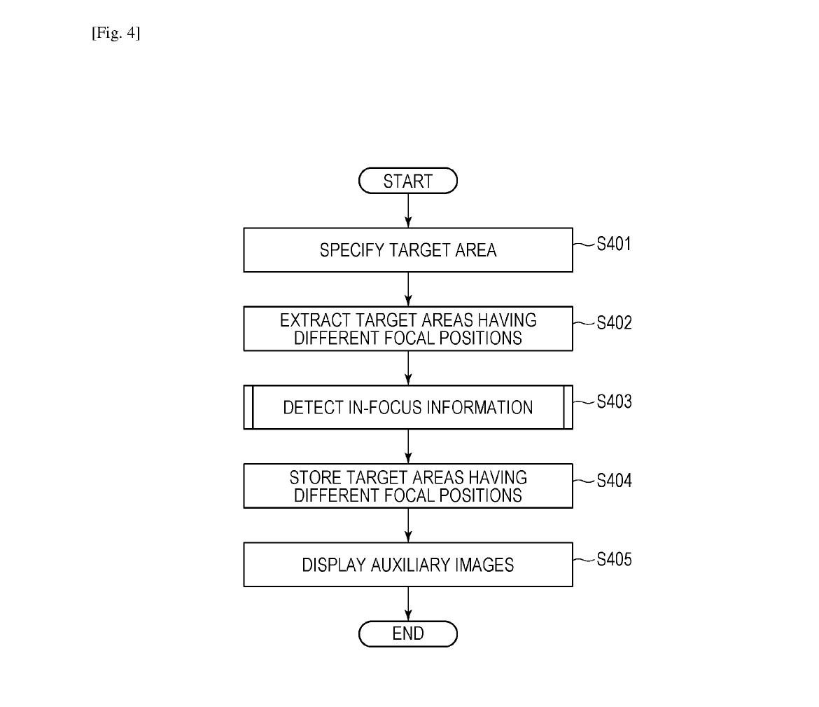

The operations of the image processing apparatus 102 according to the first embodiment will be described with reference to FIGS. 4 to 7B. Unless otherwise specified, processes described below are achieved with the CPU of the image processing apparatus 102 which executes programs. Note that the image processing apparatus 102 may be configured by installing programs which cause a general-purpose computer to achieve functions described below, as in the first embodiment, or may be configured with dedicated hardware and programs.

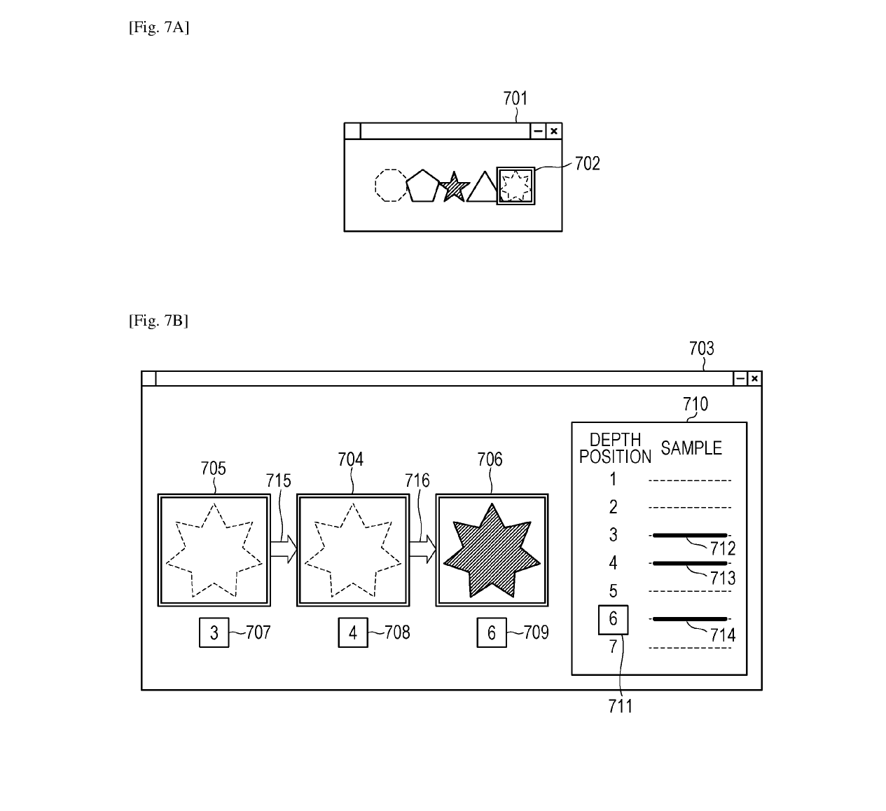

FIG. 4 is a flowchart of image presentation. In step S401, a target area is specified. In this step, a range to be observed in detail is specified in the XY directions as well as in the depth direction (Z direction). The image processing apparatus 102 displays a target-area specification screen on the display apparatus 103, and a target area is specified through a user operation to the target-area specification screen. Thus, the image processing apparatus 102 obtains information about the target area, such as position information. An exemplary target-area specification screen will be described with reference to FIG. 7A.

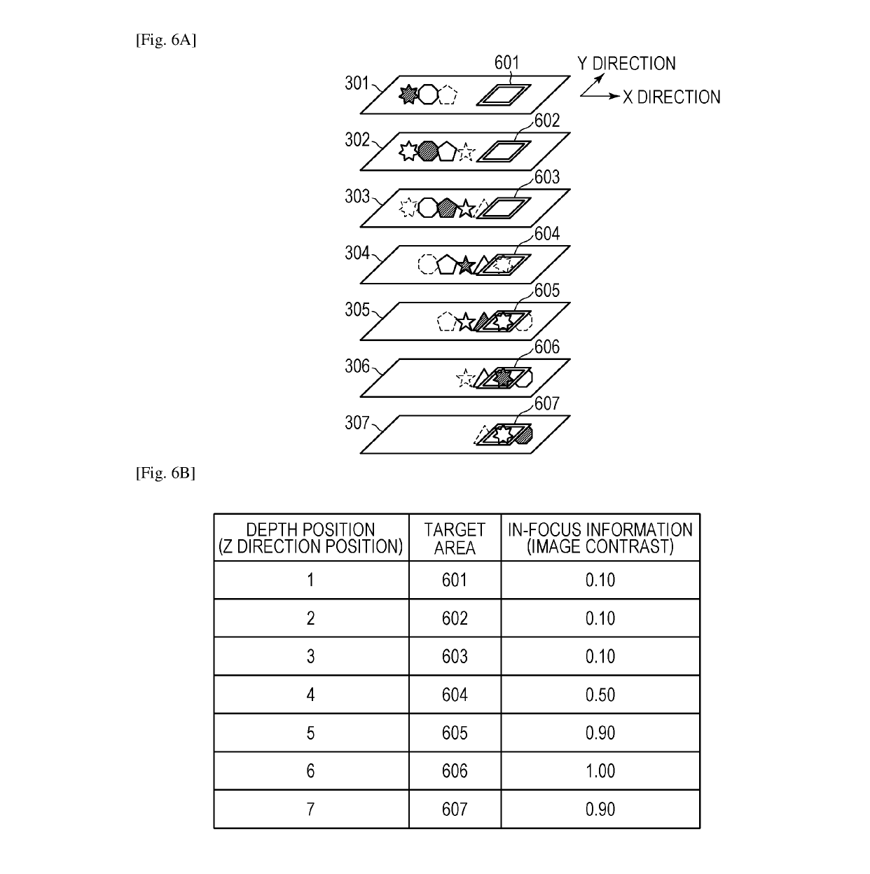

In step S402, target areas are extracted in multiple layer images having different focal positions. An example of the extraction of target areas will be described with reference to FIG. 6A.

In step S403, in-focus information is detected. An image contrast which is in-focus information is detected for each of the target areas extracted in step S402. An in-focus area (in-focus image among the target areas) is specified through the detection of in-focus information. The process flow of the detection of in-focus information, and the in-focus information will be described with reference to FIG. 5.

In step S404, the multiple target areas obtained at different focal positions are stored. The multiple target areas extracted in step S402 are used for a user to perform detailed observation in the depth direction (Z direction). Therefore, the target areas are highly likely to be displayed at once. Accordingly, to perform smooth rendering on the display apparatus 103, the multiple target areas are temporarily stored in a display memory.

In step S405, auxiliary areas are displayed. An image selected by a user as a target area (target area in the observation image; observation area), and the target areas (auxiliary areas) in the layer images whose focal positions are before and after that of the observation area are displayed. In addition, information based on the results of the detection of in-focus information performed in step S403 is also displayed. An exemplary auxiliary-area presentation screen including auxiliary areas will be described with reference to FIG. 7B.

Through the above-described processing steps, the target area and its auxiliary areas are displayed. The display of auxiliary areas enables a user to easily perform detailed observation in the depth direction (Z direction) and selection of the in-focus area.

FIG. 5 is a flowchart of the detection of in-focus information.

In step S501, any target area is selected from the multiple target areas extracted in step S402.

In step S502, the target area selected in step S501 is obtained.

In step S503, an image contrast of the target area obtained in step S502 is detected. An image contrast can be calculated using the following expression, where E represents an image contrast and L(m, n) represents a luminance component of a pixel. Here, m represents a pixel position in the Y direction, and n represents a pixel position in the X direction.

E=Σ(L(m,n+1)−L(m,n))²+Σ(L(m+1,n)−L(m,n))² [Math. 1]

The first term on the right hand side represents luminance differences between pixels adjacent to each other in the X direction, and the second term represents luminance differences between pixels adjacent to each other in the Y direction. An image contrast E is an index indicating squared-sums of luminance differences between pixels adjacent to each other in the X direction and in the Y direction. In FIG. 6B, a value is used which is obtained by normalizing an image contrast E into a value from 0 to 1 as described below.

In step S504, it is determined whether or not in-focus information (image contrast) has been detected for all of the target areas. If a target area whose image contrast has not been detected is present, the process proceeds to step S505, and a target area that has not been processed is selected as a target area to be processed next. If it is determined, in step S504, that the detection of an image contrast is completed for all of the target areas, the process ends.

In step S505, a target area that has not been processed is selected as a target area to be processed next, and the process proceeds to step S502.

In the above description, an example is described in which a squared-sum of luminance differences is used as an image contrast. However, a method for obtaining an image contrast is not limited to this. In another exemplary method for obtaining an image contrast, a discrete cosine transform is performed to obtain frequency components, and a total sum of high-frequency components among the frequency components is obtained. Alternatively, edge detection is performed using an edge detection filter, and the obtained edge components may be used as the degree of contrast. Instead, the maximum and the minimum of luminance values are detected, and the difference between the maximum and the minimum may be used as the degree of contrast. Other than these, various existing methods may be applied to the contrast detection.

As described above, an image contrast can be detected for all of the target areas.

FIGS. 6A and 6B are schematic diagrams describing multiple target areas and their in-focus information. FIG. 6A illustrates exemplary extraction of target areas. In the layer image 304, a target area 604 is extracted. In the layer images 301 to 303 and 305 to 307, target areas 601 to 603 and 605 to 607 are extracted as an area corresponding to the target area 604 in the layer image 304. FIG. 6B illustrates an exemplary table showing the relationship between a target area and its in-focus information (image contrast). The value of in-focus information (image contrast) for the target area 606 is the highest, and the target area 606 is the in-focus area (in-focus image among the target areas).

The above-described multiple target areas and their in-focus information are used to specify the in-focus area and to display auxiliary areas.

FIGS. 7A and 7B are schematic diagrams illustrating a target-area specification screen and an auxiliary-area presentation screen. Here, user operation screens used in the display control described in steps 5401 and 5405 will be described.

FIG. 7A illustrates an exemplary target-area specification screen. In an image display window 701, the entire layer image 304 captured at a certain focal position is displayed. A user, for example, drags the mouse or inputs values from the keyboard, whereby the user can specify a position in the XY directions and the size of a target area 702. For example, the image display window 701 may be used in such a manner that a user specifies, as the target area 702, a portion which is determined to need to be observed in detail in the depth direction (Z direction) among images displayed in the image display window 701. When it is necessary to observe the entire image in the depth direction, the entire area of the image may be specified. The target area 702 in FIG. 7A corresponds to the target area 604 in the layer image 304 in FIG. 6A. FIG. 7B illustrates an exemplary auxiliary-area presentation screen. A window 703 is an auxiliary area window. Here, the auxiliary area window 703 is displayed as a window different from the image display window 701 illustrated in FIG. 7A. A target area (observation area) 704 is an area in the observation image selected by the user. Auxiliary areas 705 and 706 are target areas (corresponding areas) in layer images whose focal positions are different from that of the observation area. The auxiliary areas 705 and 706 are located in such a manner that the focal positions of the auxiliary areas 705 and 706 are before and after that of the observation area. In the depth direction (Z direction) in FIG. 3, the depth position of the observation area is “4”, whereas the depth position of the auxiliary area 705 is “3” and the depth position of the auxiliary area 706 is “6”. Depth positions (Z positions) 707 to 709 indicate those of the observation area and the auxiliary areas. An area 710 is used to graphically display the depth position and the sample. To easily understand the depth positions (Z positions) of the observation and auxiliary areas 707 to 709, lines 712 to 714 indicating these areas are displayed with emphasis by changing them, for example, in thickness, in length, or in color. Similarly, the depth position of the in-focus area is displayed with emphasis, for example, by surrounding it with a rectangle as denoted by a reference numeral 711. Arrows 715 and 716 indicate the in-focus direction. The tip of an arrow indicates that the in-focus state is located in this direction. The observation area 704 is closer to the in-focus state than the auxiliary area 705. Accordingly, the arrow 715 is oriented to the right. Similarly, when the auxiliary area 706 is compared with the observation area 704, the auxiliary area 706 is the in-focus area. Accordingly, the arrow 716 is oriented to the right.

By using the target-area specification screen and the auxiliary-area presentation screen described above, a user can easily perform detailed observation in the depth direction (Z direction) and selection of the in-focus area.

Here, two auxiliary areas obtained from two layer images whose focal positions are before and after that of the observation area are displayed at the same time. Alternatively, either one of the areas, e.g., the in-focus area, may be displayed at the same time.

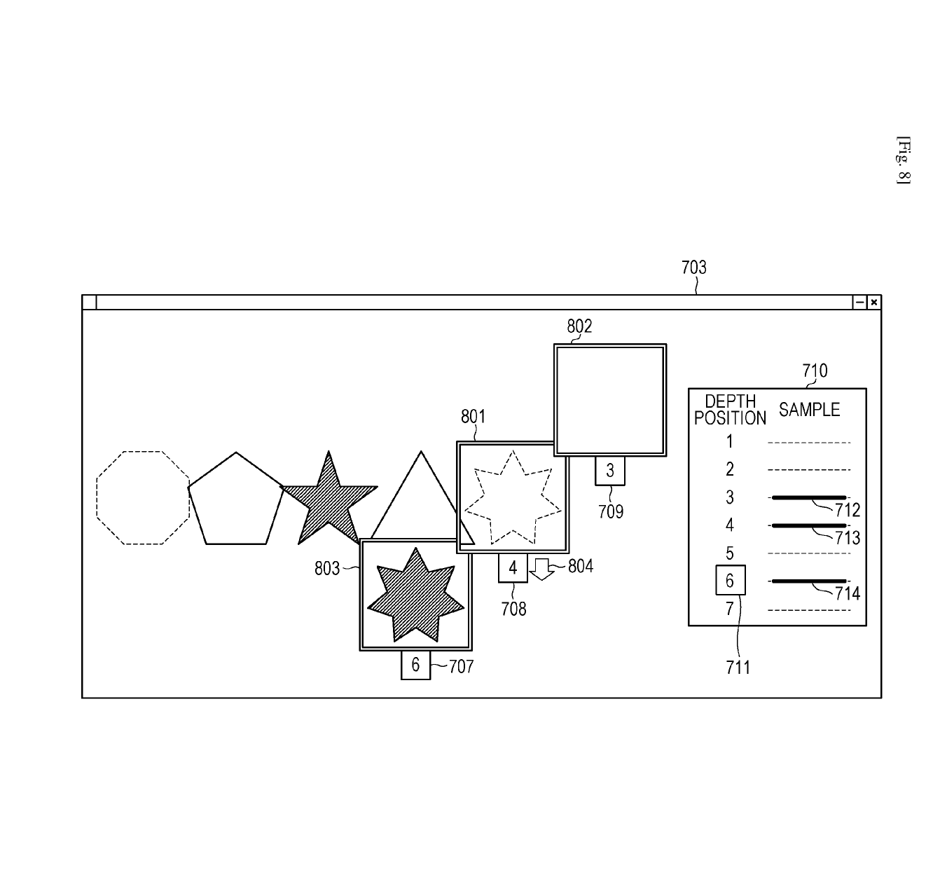

FIG. 8 is a schematic diagram illustrating another embodiment of the target-area specification screen and the auxiliary-area presentation screen. In FIGS. 7A and 7B, the target-area specification screen and the auxiliary-area presentation screen are displayed in different windows. In FIG. 8, they are displayed in the same window. In addition, FIG. 8 illustrates the example in which the way to present the auxiliary areas is different from that in FIGS. 7A and 7B. The same components as those in FIGS. 7A and 7B are designated with the identical reference numerals.

A target area (observation area) 801 is an area in the observation image selected by the user. Auxiliary areas 802 and 803 are target areas (corresponding areas) in layer images whose focal positions are different from that of the observation area 801. The auxiliary areas 802 and 803 are located in such a manner that the focal positions of the auxiliary areas 802 and 803 are before and after that of the observation area 801. In the depth direction (Z direction) in FIG. 3, the depth position of the observation area 801 is “4”, whereas the depth position of the auxiliary area 802 is “3” and the depth position of the auxiliary area 803 is “6”. An arrow 804 indicates the in-focus direction. The tip of the arrow indicates that the in-focus state is located in this direction. A deeper position from the observation area 801 in the depth direction (Z direction) is closer to the in-focus state. Accordingly, the arrow is oriented downward. When the target area 801 is specified in a screen corresponding to the target-area specification screen in FIG. 7A, the auxiliary areas 802 and 803 are displayed near the target area 801. To easily and intuitively understand the depth positions (Z positions) of the auxiliary areas, the auxiliary areas are displayed so as to overlap the observation area 801. The overlap relationship indicating which auxiliary area is before the observation area and which auxiliary area is after the observation area directly reflects the depth positions (Z positions).

Each of FIGS. 7A to 8 illustrates only an example of a target-area specification screen and/or an auxiliary-area presentation screen. As long as two or more auxiliary areas and the depth positions of an observation area and the auxiliary areas can be displayed, any form of a setting screen may be used.

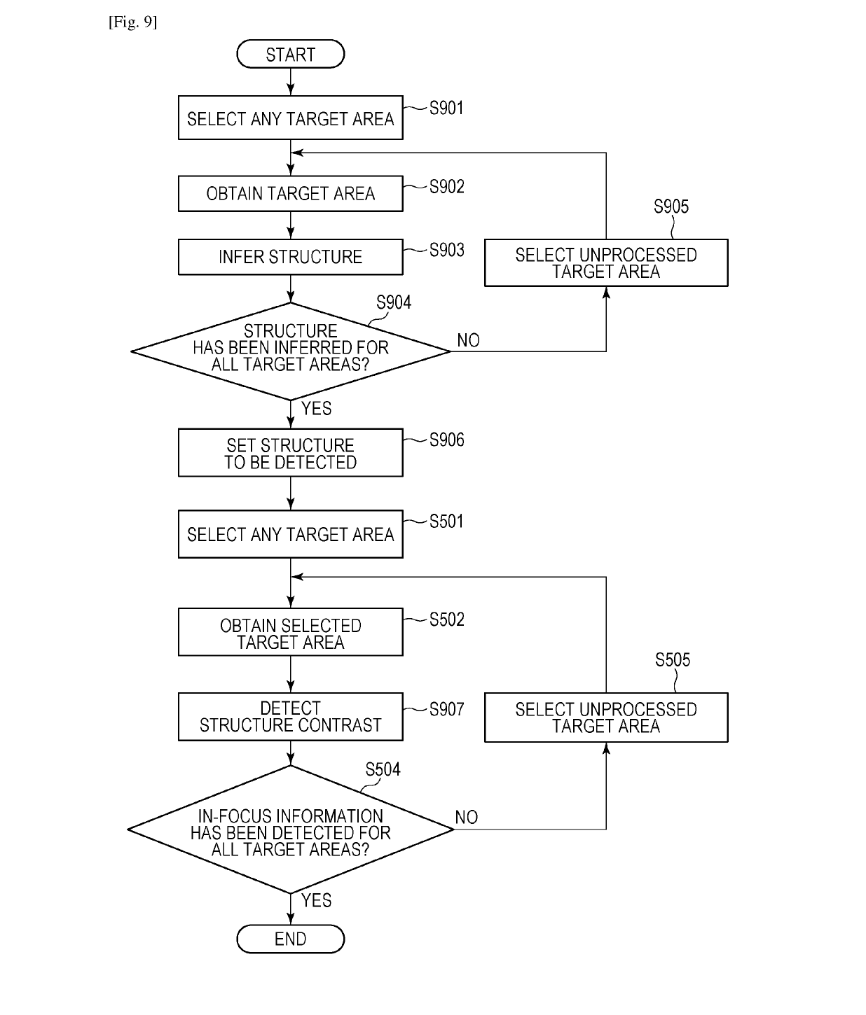

FIG. 9 is a flowchart of detection of in-focus information for an inferred structure. In FIG. 5, an example is described in which an image contrast is used as in-focus information. In FIG. 9, a method will be described in which a structure is inferred, and in which a contrast is detected for the inferred structure.

In step S901, any target area is selected from the multiple target areas extracted in step S402.

In step S902, the target area selected in step S901 is obtained.

In step S903, the structure in the target area obtained in step S902 is inferred. The structure indicates, for example, a cell nucleus. In the case where the subject (sample) is a hematoxylin-eosin (HE) stained sample, a cell nucleus is stained in dark bluish purple by hematoxylin. On the basis of this color information or information describing that the form is approximately a circle, the structure of a cell nucleus is inferred. Machine learning such as a support vector machine (SVM) is also used, enabling the structure to be efficiently inferred.

In step S904, it is determined whether or not the structure is inferred for all of the target areas. If a target area which has not been subjected to the structure inference is present, the process proceeds to step S905, and a target area which has not been processed is selected as a target area to be processed next. If it is determined, in step S904, that the structure inference is completed for all of the target areas, the process proceeds to step S906.

In step S905, a target area which has not been processed is selected as a target area to be processed next, and the process proceeds to step S902.

In step S906, structures to be detected are set. As illustrated in FIG. 3, the layer images have different focal positions. Accordingly, the structures inferred in step S903 are different from each other depending on the layer images. Here, structures to be detected are set so as to include all of the structures inferred in step S903. Explanation corresponding to FIG. 3 is that all of the structures of the observation objects 308 and 311 to 316 are set as structures to be detected. Position data (coordinates data) of the structures to be detected is stored, and it is used in a processing step of detecting structure contrasts described below.

In step S907, structure contrasts in the target area obtained in step S502 are detected. Image contrasts described in FIG. 5 are obtained for the structures that are set in step S906, in the layer image. Explanation corresponding to FIG. 3 is that contrasts are obtained for the structures of the observation objects 314 to 316 in the layer image 307. Contrasts are to be detected at positions where the structures of the observation objects 308 and 311 to 313 are present, but these observation objects are blurred and their contrasts are difficult to be detected.

As described above, structure contrasts can be detected for all of the target areas. By using structure contrasts, the contrast of a structure which is a focus point in a target area can be detected, and more accurate in-focus state can be grasped for an observation object.

In observation of a HE stained sample, an observer observes all over the entire area of an image. Accordingly, it is desirable that the entire image be focused in terms of ease of observation. Therefore, it is desirable to use an image contrast as in-focus information. On the other hand, for an immuno-histochemical staining (IHC) sample, target areas are often limited and the object of observation is clear, such as counting of cancerous nucleuses. In counting of cancerous nucleuses, the in-focus state of the nucleuses is important. Accordingly, it is desirable that structures in a target area be focused in terms of ease of observation. Therefore, a structure contrast is desirably used as in-focus information.

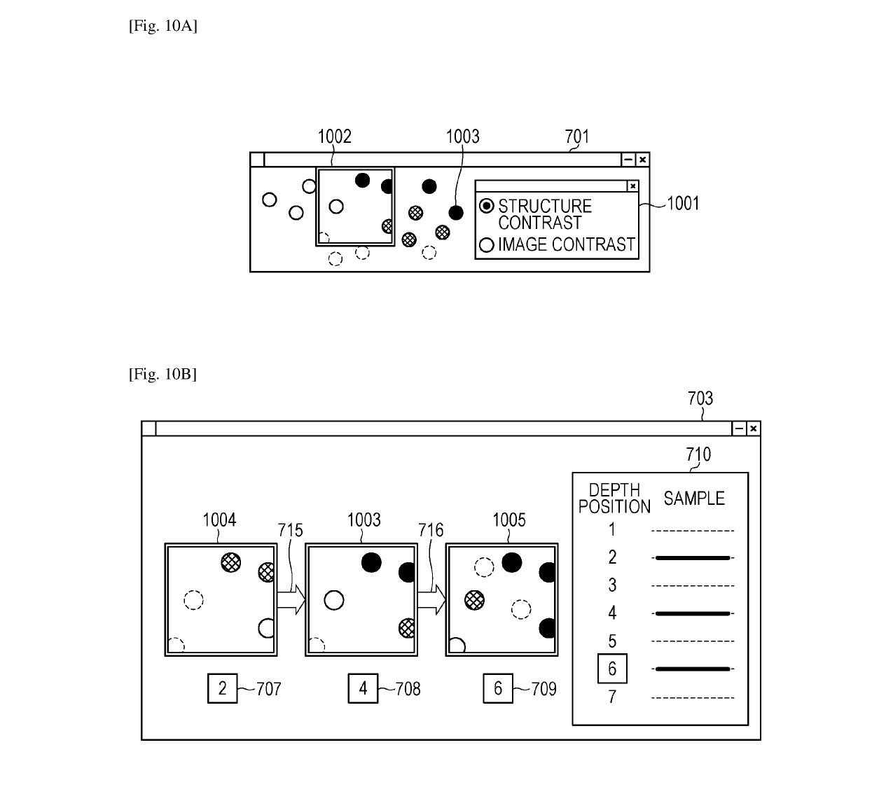

FIGS. 10A and 10B are schematic diagrams illustrating a presentation image in which a method for detecting in-focus information is selected. The same components as those in FIGS. 7A and 7B are designated with identical reference numerals.

FIG. 10A is a schematic diagram illustrating a target-area specification screen. A window 1001 is used for selecting a method for detecting in-focus information. In the window 1001, a method using a structure contrast or a method using an image contrast can be selected. A user can specify a position in the XY directions and the size of a target area 1002 by dragging the mouse or inputting values from the keyboard. A cell nucleus 1003 indicates one cell nucleus. Some cell nucleuses are distributed which are represented by a black circle, a circle filled with a mesh, a white circle, and a circle drawn with a dashed line, the sequence of which indicates a sequence of focus states from the in-focus state to the out-of-focus state.

FIG. 10B is a schematic diagram illustrating an auxiliary-area presentation screen. A target area (observation area) 1002 is an area in an observation image selected by a user. Auxiliary areas 1004 and 1005 are target areas (corresponding areas) in layer images whose focal positions are different from that of the observation area. The auxiliary areas 1004 and 1005 are located in such a manner that the focal positions of the auxiliary areas 1004 and 1005 are before and after that of the observation area. The depth position of the observation area 1002 is “4”, whereas the depth position of the auxiliary area 1004 is “2” and the depth position of the auxiliary area 1005 is “6”. Since a structure contrast is used as in-focus information, pinpoint detection of the contrast of a cell nucleus which is a focus point in a target area can be performed, and the observation object (cell nucleus) can be grasped more accurately.

As described above, the expansion of types of a contrast for an image enables a method for detecting in-focus information to be easily selected.

FIGS. 11A to 11C are schematic diagrams describing priority for target areas. In step S404 in FIG. 4, multiple target areas are temporarily stored on the display memory. When the number of layer images and the number of target areas increase, the data volume of the target areas may exceed the capacity of the display memory. Here, to address this problem, priorities are assigned to the multiple target areas, and target areas having a higher priority are stored on the display memory in descending order of priority. A priority is assigned to a target area from a viewpoint of whether a user highly likely observes the target area.

FIG. 11A is a diagram illustrating pieces of in-focus information (image contrasts) corresponding to multiple target areas whose focal positions are different from each other. The horizontal axis represents a position in the depth direction (Z direction), and the vertical axis represents in-focus information (image contrast). A curve 1101 indicates pieces of in-focus information (image contrasts) corresponding to multiple target areas. A line 1102 indicates a position in the depth direction (Z direction) of the observation area, and a line 1103 indicates the position in the depth direction (Z direction) of the in-focus target area. The depth position of a target area having in-focus information (image contrast) of the highest value is “23”, and the depth position of the observation area is “29”.

FIG. 11B illustrates a table showing the relationship among a position in the depth direction (Z direction), in-focus information (image contrast), and a priority. The positions in the depth direction (Z direction) and pieces of the value information of in-focus information (image contrasts) correspond to those in FIG. 11A. The depth position of an observation area 1104 is “29”, and its priority is set to “3” which is the highest value. The observation area is an area which the user is observing, and its image is being displayed at the observation time point, resulting in its priority being set to the highest value. The depth position of an in-focus area 1105 which is a target area having in-focus information (image contrast) of the highest value is “23”, and its priority is set to “2”. It is highly likely that the user observes the in-focus area among the target areas. Therefore, the second priority which is subsequent to that of the display image at the observation time point is assigned to the in-focus area. A priority “1” which is subsequent to that of the in-focus area is set to the target areas whose positions in the depth direction (Z direction) are between that of the observation area 1104 and that of the in-focus area 1105. This is because consideration is given to a high possibility that a user performs observation by moving a position in the depth direction (Z direction) from the observation area to the in-focus area with a sweep. The lowest priority “0” is set to target areas whose positions in the depth direction (Z direction) are not between that of the observation area 1104 and that of the in-focus area 1105.

FIG. 11C illustrates a table showing the relationship among a memory storage number, a priority, and the depth position of a stored target area. Here, it is assumed that 20 target areas can be stored on the display memory. The target areas are stored on the display memory on descending order of the priority.

There are multiple target areas having the priority “1”. Here, the target areas are stored in the following procedure. A target area TA1 which is located at the middle between the area of the priority “3” and the area of the priority “2” is determined, and is stored on the display memory. Then, a target area TA2 which is located at the middle between the area of the priority “3” and the target area TA1 is determined, and is stored on the display memory. Then, a target area TA3 which is located at the middle between the area of the priority “2” and the target area TA1 is determined, and is stored on the display memory. After that, a similar procedure is repeated, and the order of storage of the target areas having the priority “1” onto the display memory is determined. In the case where a target area is not present at the middle, that is, in the case where two target areas are present at the middle, a rule may be defined, such as a rule that a target area located at a deeper position is to be selected. This is a method for determining the priority by repeating a process of equal division. There are multiple target areas having the priority “0”. For such target areas, a method is employed in which a target area closer to the area of the priority “3” and a target area closer to the area of the priority “2” are alternately stored on the display memory.

As described above, a priority is assigned to a target area from a viewpoint of whether a user highly likely observes the target area, and target areas are stored on the display memory in accordance with their priorities, enabling the target areas to be quickly displayed with ease of operation.

FIG. 12 is a flowchart describing priorities assigned to target areas.

In step S1201, a priority is assigned to the observation area. Referring to FIGS. 11A to 11C, the depth position of the observation area 1104 is “29”, and its priority is set to “3” which is the highest value.

In step S1202, a priority is assigned to the in-focus area. Referring to FIGS. 11A to 11C, the depth position of the in-focus area 1105 is “23”, and its priority is set to “2” which is the second-highest value subsequent to that of the observation area.

In step S1203, a priority is assigned to target areas that are located between the observation area and the in-focus area. Referring to FIGS. 11A to 11C, the priority “1” which is subsequent to the priority for the in-focus area is set to target areas whose positions in the depth direction (Z direction) are between that of the observation area 1104 and that of the in-focus area 1105.

In step S1204, a priority is assigned to target areas that are not located between the observation area and the in-focus area. Referring to FIGS. 11A to 11C, the lowest priority “0” is set to target areas whose positions in the depth direction (Z direction) are not between that of the observation area 1104 and that of the in-focus area 1105.

By assigning priorities to target areas according to the above-described flow, target areas which are highly likely to be observed by a user are stored on the display memory in descending order of priority, enabling target areas to be quickly displayed with ease of operation.

According to the first embodiment described above, the depth position of a subject (sample) in the in-focus state can be easily grasped in observation of the subject (sample) using digital images. This enables detailed observation in the depth direction for the subject (sample) to be easily performed.

Further, even when the memory capacity is limited, display responsivity and display operability are improved. This enables detailed observation in the depth direction for a subject (sample) to be performed without any stress.

### Second Embodiment

The above-described embodiment is described under the assumption that the embodiment is used mainly in histological diagnosis in which the structure of a tissue is observed in a section. In histological diagnosis, the thickness of a sample is as thin as several micrometers, and Z-stack image data is used to deal with blurring of an image due to an influence of the unevenness of the sample surface or optical aberration. Therefore, an observer is basically interested in the in-focus area, and uses the Z-stack image data around the in-focus area in an auxiliary manner In contrast, in cytological diagnosis, the thickness of a sample is as thick as several tens to several hundreds of micrometers, and the three-dimensional structure of a cell or a cell clump is observed. The Z-stack image data is used in cytological diagnosis in terms of grasping of a three-dimensional structure. Therefore, in cytological diagnosis, a display method in which a three-dimensional structure is easily grasped is important. A display method in which a three-dimensional structure can be easily grasped in cytological diagnosis will be described below.

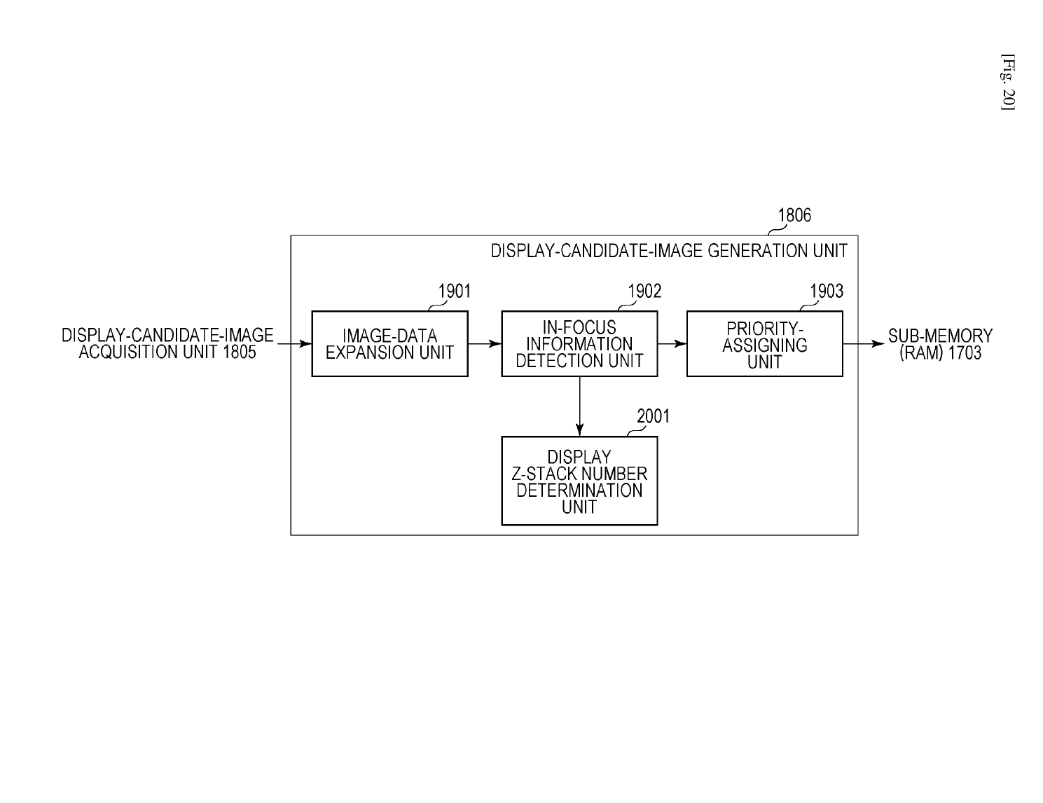

FIG. 20 is a block diagram illustrating a functional configuration of the display-candidate-image generation unit 1806 in the controller 1701 of the image processing apparatus 102 according to a second embodiment of the present invention. The descriptions about the image-data expansion unit 1901, the in-focus information detection unit 1902, and the priority-assigning unit 1903 are similar to those made with reference to FIG. 19.

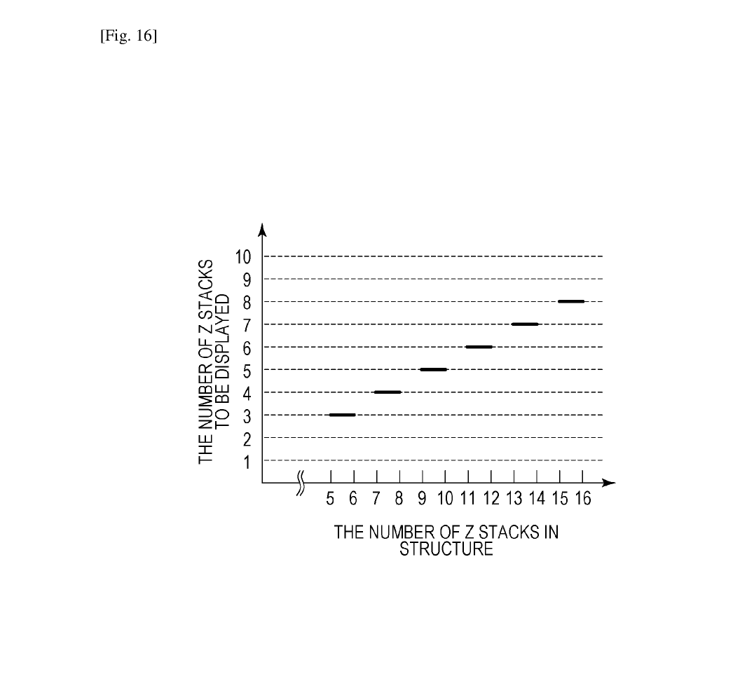

A display Z-stack number determination unit 2001 determines the number of Z stacks to be displayed on the basis of the in-focus information detected by the in-focus information detection unit 1902. The number of Z stacks to be displayed is the number of areas constituted by a target area (observation area) in the observation image and auxiliary areas. The method for determining the number of Z stacks will be described with reference to FIG. 16.

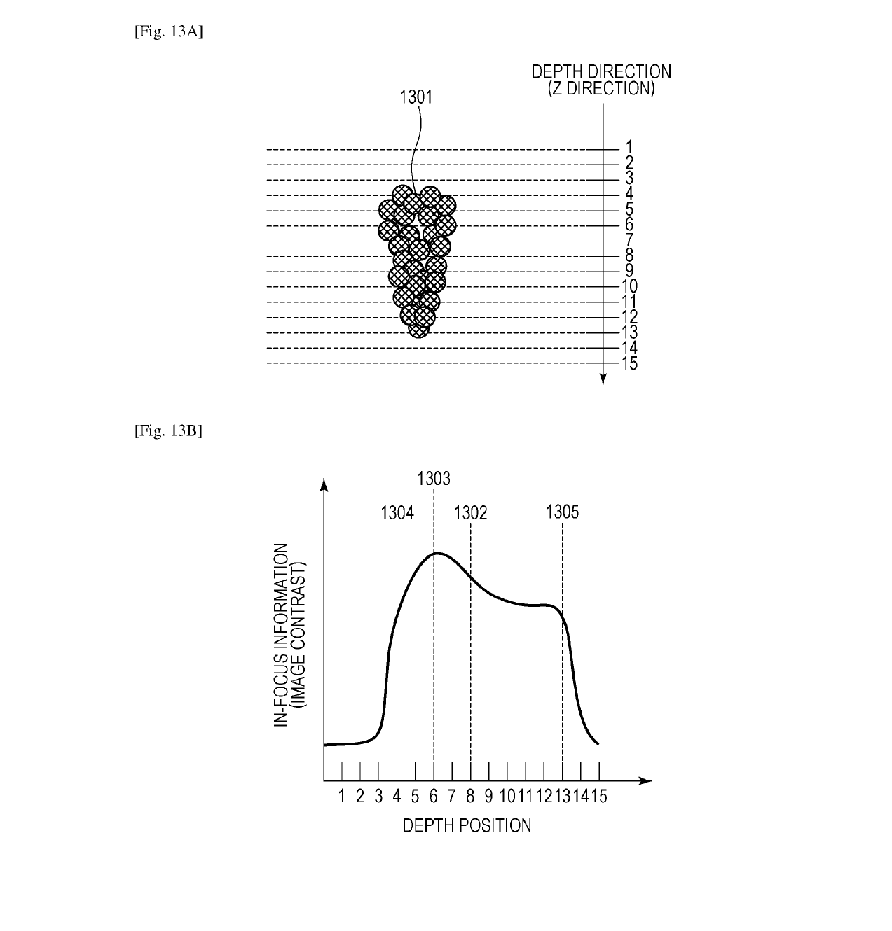

FIGS. 13A and 13B are schematic diagrams describing a cell clump and its in-focus information.

FIG. 13A is a diagram illustrating positions in the depth direction (positions in the Z direction) obtained when Z-stack image data for a cell clump 1301 is obtained. The cell clump 1301 is present in the depth direction approximately from the depth position “4” to the depth position “13”. An observer observes 10 images in Z-stack image data from the depth position “4” to the depth position “13”, and grasps the three-dimensional structure of the cell clump 1301.

FIG. 13B is a diagram illustrating in-focus information (structure contrast) for the cell clump 1301. The horizontal axis represents the depth position of Z-stack image data, and the vertical axis represents in-focus information (structure contrast) for a target area. The structure contrasts for the Z-stack image data from the depth position “4” to the depth position “13”, in which the cell clump 1301 is present, have relatively high values. The structure contrasts for the Z-stack image data at the depth positions “1”, “2”, “3”, “14”, and “15”, in which the cell clump 1301 is not present, have low values. The depth range (Z-direction range) of the cell clump 1301 can be estimated from the in-focus information (structure contrast). The depth range (Z-direction range) is a range in which the cell clump 1301 is present in the depth direction (Z direction). The depth position “4” which is the lower limit of the presence of the cell clump 1301 is represented by a structure lower limit 1304, and the depth position “13” which is the upper limit of the presence of the cell clump 1301 is represented by a structure upper limit 1305. The target area at the depth position “6” which indicates the highest structure contrast is an in-focus area 1303. It is determined that the cell clump 1301 is present from the depth position “4” to the depth position “13” on the basis of the in-focus information (structure contrast) of the cell clump 1301, and the determination information is used to perform display so that the three-dimensional structure is easily grasped.

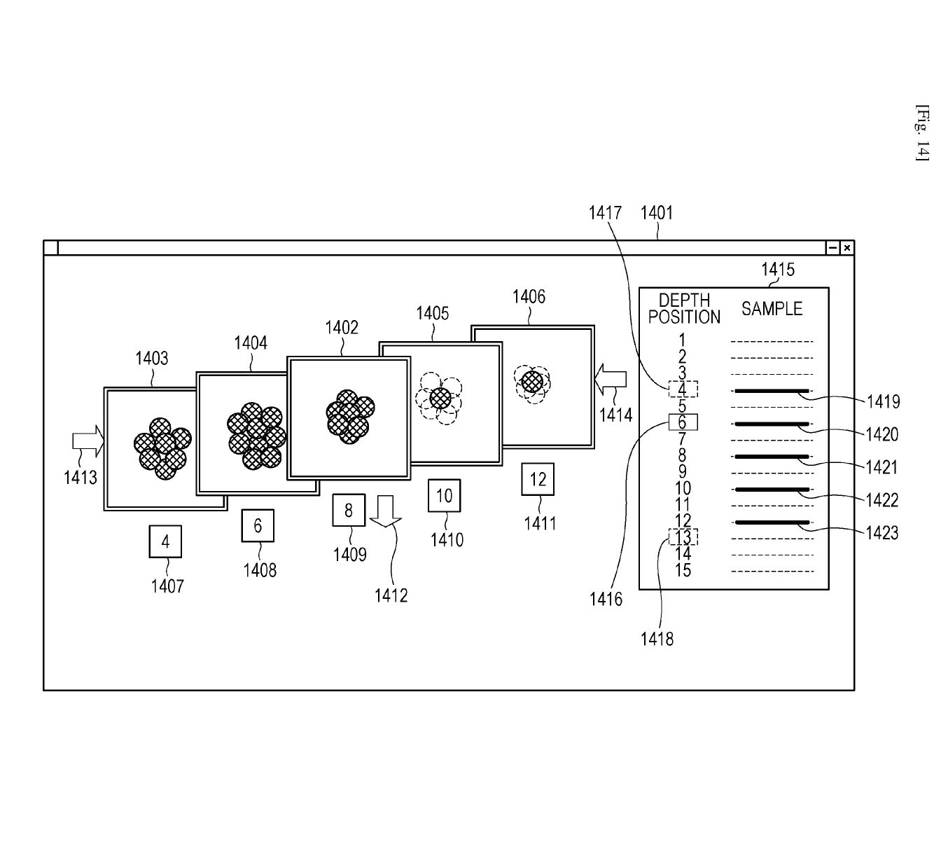

FIG. 14 illustrates an exemplary auxiliary-area presentation screen. A window 1401 is an auxiliary area window. Here, the auxiliary area window 1401 is displayed in a window different from an image display window in which the entire Z-stack image data captured at a certain focal position is displayed. A target area (observation area) 1402 is an area in an observation image selected by a user. Auxiliary areas 1403 to 1406 are target areas (corresponding areas) in Z-stack image data whose focal positions are different from that of the observation area. The auxiliary areas 1403 to 1406 are located at focal positions to which the focal position of the observation area 1402 is to be changed sequentially. Referring to the depth direction (Z direction) in FIG. 13A, the depth position of the observation area 1402 is “8”, whereas the depth positions of the auxiliary areas 1403, 1404, 1405, and 1406 are “4”, “6”, “10”, and “12”, respectively. Depth positions (Z positions) 1407 to 1411 indicate those of the observation area 1402 and the auxiliary areas 1403 to 1406. An area 1415 is used to graphically display the depth position and the sample. To easily understand the depth positions (Z positions) 1407 to 1411 of the observation and auxiliary areas, lines 1419 to 1423 indicating these areas are displayed with emphasis by changing them, for example, in thickness, in length, or in color. Similarly, the depth position of the in-focus area is displayed with emphasis, for example, by surrounding it with a rectangle as denoted by a reference numeral 1416. The depth positions of the structure lower limit and the structure upper limit are displayed with emphasis, for example, by surrounding each of them with a dotted rectangle as denoted by reference numerals 1417 and 1418. An arrow 1412 indicates the in-focus direction. The tip of the arrow indicates that the in-focus state is located in this direction. The direction in which the depth position becomes deeper is represented by an arrow which is oriented upward, whereas the direction in which the depth position becomes shallower is represented by an arrow which is oriented downward. The in-focus area 1404 is located in the direction in which the depth position becomes shallower with respect to the observation area 1402. Accordingly, the arrow 1412 is oriented downward. Arrows 1413 and 1414 indicate the structure lower limit and the structure upper limit, respectively. The arrows 1413 and 1414 indicate that the target area (observation area) 1402 and the auxiliary areas 1403 to 1406 are present between the structure lower limit and the structure upper limit

Five screens constituted by one screen for the target area (observation area) and four screens for the auxiliary areas are displayed. The target area (observation area) is displayed in the foreground, and auxiliary areas are also displayed at the same time. In addition, a prime consideration is given to grasping of the entire three-dimensional structure, and the Z-stack image data for the target area (observation area) and the auxiliary areas is displayed in such a manner that their focal positions are apart from each other at equal intervals. This enables detailed observation of the target area (observation area). By concurrently using multiple auxiliary areas, a display method is achieved in which the entire three-dimensional structure is easily grasped.

By using the auxiliary-area presentation screen described above, a user can easily perform detailed observation in the depth direction (Z direction), and can easily grasp the three-dimensional structure of a cell clump.

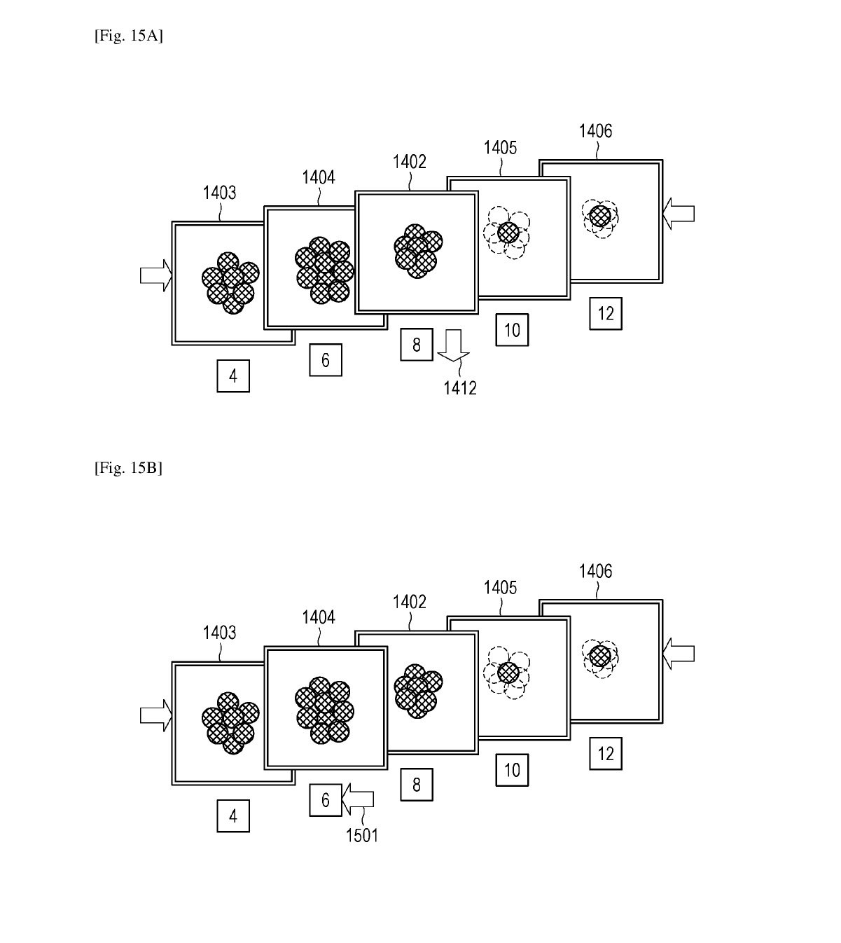

FIGS. 15A and 15B are schematic diagrams describing switching of the target area (observation area) in the auxiliary-area presentation screen. FIGS. 15A and 15B illustrate the target area (observation area) and the auxiliary areas in the auxiliary area window 1401. FIG. 15A is similar to FIG. 14. The target area (observation area) 1402 indicates an area in the observation image selected by a user, and the auxiliary areas 1403 to 1406 indicate target areas (corresponding areas) in the Z-stack image data whose focal positions are different from that of the observation area. Since the auxiliary area 1404 is the in-focus area, the arrow 1412 indicating the in-focus direction is oriented downward. FIG. 15B illustrates a display screen obtained after the Z position of the target area (observation area) is switched. The in-focus area 1404 is selected as the Z position of the target area (observation area). Accordingly, the in-focus area 1404 is displayed in the foreground, and an arrow 1501 indicating the in-focus direction is oriented in the horizontal direction.

As described above, also upon switching of the target area (observation area), the target area in the observation image and target areas (corresponding areas) in Z-stack image data whose focal positions are different from that of the observation area are constantly displayed, achieving easy grasping of the three-dimensional structure of a cell clump.

FIG. 16 illustrates exemplary relationship between the number of Z stacks in a structure and the number of Z stacks to be displayed. The horizontal axis represents the number of Z stacks in a structure which indicates a depth range in which an observation object such as a cell clump is present, and the vertical axis represents the number of Z stacks to be displayed, which indicates the number of areas constituted by a target area (observation area) in an observation image and auxiliary areas. In the example of the cell clump 1301 described with reference to FIGS. 13A to 14, the number of Z stacks in a structure on the horizontal axis is “10”, and the number of Z stacks to be displayed on the vertical axis is “5”. As illustrated in FIG. 16, it is desirable that the number of areas constituted by a target area (observation area) and auxiliary areas be determined depending on a range in which an observation object such as a cell clump is present in the depth direction. In the case where the depth range of an observation object is relatively wide, the number of auxiliary areas is increased, achieving easy grasping of the three-dimensional structure.

According to the embodiments described above, the three-dimensional structure of a subject (sample) can be easily grasped in observation of the subject (sample) using digital images.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-286779, filed Dec. 27, 2011, and Japanese Patent Application No. 2012-226899, filed Oct. 12, 2012, which are hereby incorporated by reference herein in their entirety.

1. An image processing apparatus comprising:
an image data acquisition unit configured to acquire Z-stack image data including a plurality of layer images obtained by using a microscope apparatus;
a display control unit configured to display at least one of the plurality of layer images on a display apparatus as an observation image;
an area-information acquisition unit configured to acquire information about a target area in the observation image specified by a user; and
a detection unit configured to detect in-focus information for a corresponding area in each of the plurality of layer images, the corresponding area corresponding to the target area,
wherein the display control unit displays an image indicating a positional relationship between the target area and the corresponding area, along with the target area on the display apparatus on the basis of the detection result from the detection unit, the corresponding area being closer to an in-focus state than the target area.

2. An image processing apparatus comprising:
an image data acquisition unit configured to acquire Z-stack image data including a plurality of layer images obtained by using a microscope apparatus;
a display control unit configured to display at least one of the plurality of layer images on a display apparatus as an observation image;
an area-information acquisition unit configured to acquire information about a target area in the observation image specified by a user;
a detection unit configured to detect in-focus information for a corresponding area in each of the plurality of layer images, the corresponding area corresponding to the target area;
a priority-assigning unit configured to assign priorities to the corresponding areas on the basis of the detection result from the detection unit; and
a storage unit configured to store data about the corresponding areas having a high priority assigned by the priority-assigning unit in a storage device in descending order of priority.

3. The image processing apparatus according to claim 1, wherein the detection unit infers a structure included in each of the corresponding areas, and detects in-focus information for the inferred structure.

4. The image processing apparatus according to claim 1, wherein the display control unit displays the corresponding areas along with the target area on the display apparatus.

5. The image processing apparatus according to claim 4, further comprising:
a determination unit configured to determine a Z-direction range of an observation object from the in-focus information, and to determine the number of corresponding areas to be displayed on the display apparatus along with the target area in accordance with the Z-direction range of the observation object.

6. The image processing apparatus according to claim 5, wherein the determination unit determines the number of corresponding areas in accordance with the Z-direction range of the observation object in such a manner that the number of corresponding areas in the case where the Z-direction range of the observation object is relatively narrow is smaller than the number of corresponding areas in the case where the Z-direction range of the observation object is wide.

7. The image processing apparatus according to claim 6, wherein the determination unit determines the corresponding areas to be displayed on the display apparatus along with the target area in such a manner that focal positions of the target area and the corresponding areas are arranged at equal intervals.

8. An image processing system comprising:
an image processing apparatus that processes Z-stack image data including a plurality of layer images obtained by using a microscope apparatus, the image processing apparatus comprising
an image data acquisition unit configured to acquire the Z-stack image data,
a display control unit configured to display at least one of the plurality of layer images on the display apparatus as an observation image,
an area-information acquisition unit configured to acquire information about a target area in the observation image specified by a user, and
a detection unit configured to detect in-focus information for a corresponding area in each of the plurality of layer images, the corresponding area corresponding to the target area; and
a display apparatus that displays the Z-stack image data,
wherein the display control unit displays an image indicating a positional relationship between the target area and the corresponding area, along with the target area on the display apparatus on the basis of the detection result from the detection unit, the corresponding area being closer to an in-focus state than the target area.

9. An image processing system comprising:
an image processing apparatus that processes Z-stack image data including a plurality of layer images obtained by using a microscope apparatus, the image processing apparatus comprising
an image data acquisition unit configured to acquire the Z-stack image data,
a display control unit configured to display at least one of the plurality of layer images on the display apparatus as an observation image,
an area-information acquisition unit configured to acquire information about a target area in the observation image specified by a user, and
a detection unit configured to detect in-focus information for a corresponding area in each of the plurality of layer images, the corresponding area corresponding to the target area,
a priority-assigning unit configured to assign priorities to the corresponding areas on the basis of the detection result from the detection unit, and
a storage unit configured to store data about the corresponding areas having a high priority assigned by the priority-assigning unit in a storage device in descending order of priority; and
a display apparatus that displays the Z-stack image data.

10. An image processing method that is performed by using a computer, the method comprising:
acquiring Z-stack image data including a plurality of layer images obtained by using a microscope apparatus;
displaying at least one of the plurality of layer images on a display apparatus as an observation image;
acquiring information about a target area in the observation image specified by a user; and
detecting in-focus information for a corresponding area in each of the plurality of layer images, the corresponding area corresponding to the target area,
wherein in the displaying step, an image indicating a positional relationship between the target area and the corresponding area is displayed along with the target area on the display apparatus on the basis of the detection result obtained in the detecting step, the corresponding area being closer to an in-focus state than the target area.

11. An image processing method that is performed by using a computer, the method comprising:
acquiring Z-stack image data including a plurality of layer images obtained by using a microscope apparatus;
displaying at least one of the plurality of layer images on a display apparatus as an observation image;
acquiring information about a target area in the observation image specified by a user;
detecting in-focus information for a corresponding area in each of the plurality of layer images, the corresponding area corresponding to the target area;
assigning priorities to the corresponding areas on the basis of the detection result obtained in the detecting step; and
storing data about the corresponding areas having a high priority assigned in the priority-assigning step in a storage device in descending order of priority.

12. A computer program stored on a non-transitory computer readable medium, the program, when executed, causing a computer to execute the image processing method according to claim 10.
